(19) United States
(12) Patent Application Publication
(10) Pub. No.: US 2025/0130856 A1
(43) Pub. Date: Apr. 24, 2025

(54) APPARATUS AND COMPUTER-IMPLEMENTED METHOD FOR ALLOCATING COMPUTING RESOURCES IN A METHOD FOR PROTECTING A COMPUTER-AIDED DEVELOPMENT ENVIRONMENT IN A DISTRIBUTED DEVELOPMENT PROCESS FROM DAMAGE AND THREATS

(71) Applicant: Robert Bosch GmbH, Stuttgart (DE)

(72) Inventors: Christian Zimmermann, Stuttgart (DE); Christopher Huth, Heilbronn (DE); Fredrik Kamphuis, Weeze (DE); Markus Schweizer, Vaihingen/Enz (DE); Max Camillo Eisele, Ludwigsburg (DE); Paulius Duplys, Markgroeningen (DE); Peter Munk, Renningen (DE); Tobias Gehrmann, Stuttgart (DE)

(21) Appl. No.: 18/901,247

(22) Filed: Sep. 30, 2024

(30) Foreign Application Priority Data
Oct. 19, 2023 (DE) 10 2023 210 307.9

(51) Int. Cl. G06F 9/50; G06F 8/41

(52) U.S. Cl. CPC G06F 9/5016; G06F 8/443; G06F 2209/503

(57) ABSTRACT

An apparatus and computer-implemented method for allocating computing resources in a method for protecting a computer-aided development environment in a distributed development process from damage and threats. In the method for protecting, multiple methods for identifying damage and/or a threat in the computer-aided development environment are carried out, wherein a metric which quantifies a quality and/or informative value of the method is determined for each method, wherein a respective offer for allocating computing resources for the execution of the respective method is determined for the methods depending on said metric, wherein the computing resources are allocated to the methods depending on the respective offer.

### CROSS REFERENCE

The present application claims the benefit under 35 U.S.C. § 119 of German Patent Application No. DE 10 2023 210 307.9 filed on Oct. 19, 2023, which is expressly incorporated herein by reference in its entirety.

### FIELD

The present invention is based on an apparatus and computer-implemented method for allocating computing resources in a method for protecting a computer-aided development environment in a distributed development process from damage and threats.

### SUMMARY

A computer-implemented method for allocating computing resources in a method for protecting a computer-aided development environment in a distributed development process from damage and threats. According to an example embodiment of the present invention, in the method for protecting, multiple methods for identifying damage and/or a threat in the computer-aided development environment are carried out, wherein a metric which quantifies a quality and/or informative value of the method is determined for each method, wherein a respective offer for allocating computing resources for the execution of the respective method is determined for the methods depending on said metric, wherein the computing resources are allocated to the methods depending on the respective offer. This automates the load distribution of resources for the methods.

According to an example embodiment of the present invention, it can be provided that the offer is taken from an available budget or a budget is determined depending on the metric and the offer is taken from the budget determined depending on the metric.

According to an example embodiment of the present invention, it can be provided that the metric is determined depending on a number of errors found with the method or a number of lines of code analyzed with the method. The resources are thus allocated depending on the number.

According to an example embodiment of the present invention, it can be provided that the number is normalized using a normalization parameter and the metric represents the number normalized using the parameter. This makes it possible to determine comparable offers for metrics of different types using the same function.

According to an example embodiment of the present invention, it can be provided that the offer for the respective method is determined with a function parameterized with at least one parameter which maps the metric to the offer depending on the at least one parameter or which maps the metric and the budget to the offer depending on the at least one parameter, wherein the at least one parameter is statically specified or is learned. This means that static circumstances and changing, learnable circumstances are taken into account.

According to an example embodiment of the present invention, it can be provided that the at least one parameter is learned depending on the metric. The allocation is thus self-learning depending on the metric.

According to an example embodiment of the present invention, it can be provided that the metric and the offer are determined for the respective method in iterations and the computing resources are repeatedly allocated in iterations depending on the metrics or offers determined for the respective iteration.

According to an example embodiment of the present invention, it can be provided that the computing resources include time slots of a computing time, memory areas of a memory, or bandwidth of a data line.

According to an example embodiment of the present invention, it can be provided that the computing resources are provided on a server.

According to an example embodiment of the present invention, it can be provided that the computer-aided development environment is provided in the distributed development process on distributed devices. This means that the methods monitor the development environment on the distributed devices.

According to an example embodiment of the present invention, it can be provided that at least one of the multiple methods for identifying the damage and/or the threat is carried out on one of the distributed devices to which the at least one of the multiple methods is assigned.

According to an example embodiment of the present invention, an apparatus for allocating computing resources in a method for protecting a computer-aided development environment in a distributed development process from damage and threats provides that the apparatus comprises at least one processor and at least one memory, wherein the at least one processor is configured to carry out instructions, upon execution of which by the at least one processor the apparatus carries out the method of the present invention, wherein the at least one memory stores the instructions.

A computer program that comprises computer-executable instructions, upon execution of which by a computer the method of the present invention runs, can be provided.

Further advantageous embodiments of the present invention will become apparent from the following description and the figures.

### BRIEF DESCRIPTION OF THE DRAWINGS

FIG. 1 shows a computer-aided development environment, according to an example embodiment of the present invention.

FIG. 2 shows a flow chart with steps of a method for allocating computing resources in a method for protecting the computer-aided development environment, according to an example embodiment of the present invention.

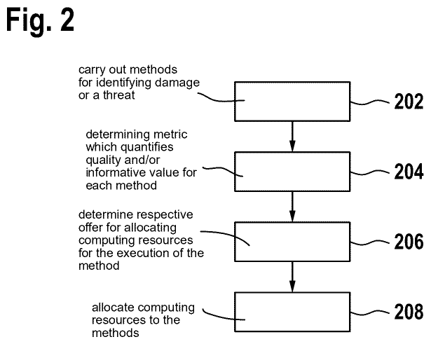

### DETAILED DESCRIPTION OF EXAMPLE EMBODIMENTS

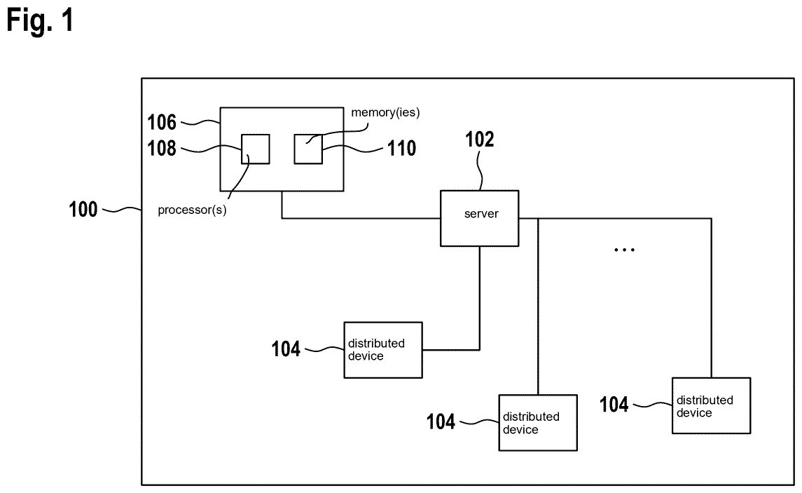

FIG. 1 shows a computer-aided development environment 100.

The development environment 100 includes a server 102 and distributed devices 104.

The development environment 100 includes an apparatus 106 for allocating computing resources in a method for protecting the computer-aided development environment 100 in a distributed development process from damage and threats.

The apparatus 106 comprises at least one processor 108 and at least one memory 110.

The at least one processor 108 is configured to carry out instructions, upon execution of which by the at least one processor 108 the apparatus 106 carries out a method described below for allocating computing resources in a method for protecting the computer-aided development environment 100 in the distributed development process from damage and threats.

The at least one memory 110 stores the instructions.

The distributed devices 106 and the server 104 are configured in the example to work together so that multiple methods for identifying damage and/or a threat are carried out in the method for protecting.

In the example, at least one of the distributed devices 106 is assigned to a method for identifying damage and/or a threat.

In the example, the server 104 provides the computing resources to be allocated.

The computing resources include time slots of a computing time on the server 104, memory areas of a memory of the server 104 or a bandwidth of a data line between the server and a distributed device 106, for example.

The method for allocating computing resources is carried out in iterations in the example.

The method for allocating computing resources includes a step 202.

In step 202, multiple methods for identifying damage and/or a threat are carried out in the method for protecting.

A respective method is carried out at least in part as a process, for instance, or as multiple processes on the server 104.

A respective method is carried out at least in part as a process, for instance, or as multiple processes on at least one of the distributed devices 106.

A respective method is allocated the computing resource for at least the part of the process that is carried out on the server 104. In a first iteration, the allocation of the computing resources can be random or according to a predetermined allocation or evenly to all methods.

The method for allocating computing resources includes a step 204.

In step 204, a metric which quantifies a quality and/or informative value of the method is determined for each method.

The computer-aided development environment is provided in the distributed development process, in particular on the distributed devices 104. The metric is determined in the distributed development process.

At least one of the multiple methods for identifying the damage and/or the threat is carried out on one of the distributed devices 104 to which the at least one of the multiple methods is assigned, for example.

The metric is determined depending on a number of errors found with the method or a number of lines of code analyzed with the method, for instance.

The number quantifies the quality, for example such that a high number represents a better quality than a comparatively lower number.

It can be provided that the number is normalized using a normalization parameter and the metric represents the number normalized using the parameter. It is thus possible to use numbers that are not directly comparable with one another. An example of normalization using a normalization parameter is a division or multiplication of the metric with a value of the normalization parameter.

The method for allocating computing resources includes a step 206.

In step 206, a respective offer for allocating computing resources for the execution of the respective method is determined for the methods depending on the metric.

In one example, the offer is taken from a budget available for the iterations.

The budget can characterize available computing time, available money or permissible power consumption. In the example, the budget defines an upper limit for the offers that can be made overall in the iterations.

In one example, a budget is determined depending on the metric and the offer per iteration is taken from the budget determined depending on the metric.

The budget is reduced in a first iteration by the taken offer, for example, and the reduced budget is available in an iteration following the first iteration.

The offer for the respective method is determined with a function parameterized with at least one parameter, for example.

In one example, the function maps the metric to the offer depending on the at least one parameter.

In one example, the function maps the metric and the budget to the offer depending on at least one parameter.

The at least one parameter can be statically specified or learned.

An example of the function with a parameter is an addition or multiplication of the metric with a value of the parameter. An example of a statically specified parameter is a parameter that has several different values, e.g. depending on time, which lead to different offers. For example, a first value of the parameter is provided for a period at night and a second value of the parameter is provided for a period during the day. The first value is greater than the second value, for instance, in order to assign more computing resources to a method at night than during the day. The first value is smaller than the second value, for instance, in order to assign more computing resources to a method during the day than at night.

The at least one parameter for a function that is assigned to a specific metric is learned depending on the specific metric, for example.

For example, in the iterations, the at least one parameter, for which the offer for the specific method leads to a greater allocation of computing resources to the specific method as the metric increases, is learned.

The method for allocating computing resources includes a step 208.

In step 208, the computing resources are allocated to the methods depending on the respective offer.

In the example, more or less of the computing resources are allocated to the methods depending on the amount of the offer. For example, more of the computing resources are allocated to a method for which there is a higher offer than to a method for which there is a comparatively lower offer.

Metrics about a development and/or an operation of one or more of the devices 104, for instance, are acquired.

The development and/or the operation of the one or more devices 104 is monitored depending on the metrics, for example.

The monitoring is carried out with the methods using the resources allocated to the respective methods.

The metric and offer are determined for the respective method in the iterations. The computing resources are repeatedly allocated in the iterations depending on the metrics or offers of the methods determined for the respective iteration.

The computing resources are provided according to the allocation, in particular on the server 102.

Step 202 is then carried out.

It can be provided that the offers for each method are determined by an agent that is assigned to the respective method.

The agent, in particular the at least one parameter, can learn to make offers in a method for reinforcement learning depending on a reward. The reward is the metric, for example, or is determined for the respective method depending on the metric for the respective method.

Example methods for identifying for a development on operations, DEVOps environment include:
Requirement analysis
Secure coding
Static automated security testing, SAST
White box dynamic automated security testing, DAST
Black box DAST
Digital sign
Security analysis
Security monitoring
Security audit
Security patch
Security scan
Security config
Secure transfer

Example metrics for identifying for a development on operations, DEVOps environment include:

### Error Density

For a method, for example, this metric is defined as:

The number of confirmed errors determined in a software or component thereof during a development period of a specified length using the method, divided by a code size of the software or component.

This makes it possible to observe and reduce error density over time.

### Error Correction Rate

This metric measures a speed, for example, with which a detected error is corrected.

This makes it possible to observe and increase the productivity of development teams.

### Critical Risk Assessment:

This metric measures a relationship between a significance of an error and a value of a vulnerability caused by the error for a possible attacker, for example.

This makes it possible to define priorities for errors to be corrected.

### Most Important Vulnerability Types:

This metric measures the most important vulnerability types for errors and the most frequently occurring vulnerability types, for example.

This makes it possible to provide a training plan for development teams with which knowledge about the error and how to avoid it can be shared.

### Number of Enemies Per Application

This metric measures how many enemies an application has, for example. This metric can be determined using a threat model or a risk analysis.

This makes it possible to determine applications in the development environment that are more at risk than other applications in the development environment. This allows the handling of these applications to be adapted.

### Rate of Repeated Hostility

This metric measures how often an enemy uses the same strategy or procedure, for example.

This makes it possible to provide appropriate training to defend against threats.

### Risk Point Per Device

This metric measures the number of vulnerabilities per device 104, for example.

This makes it possible to prioritize the vulnerabilities according to their importance. This makes it possible to pay more attention to critical vulnerabilities that can be attacked from the internet, for instance.

### Number of Continuous Delivery Cycles Per Month

This metric measures a number of successful deliveries to a production per month, for example.

This makes it possible to measure how quickly changed code is available in production.

### Number of Problems During Training

This metric measures the number of problems that are found and resolved during training, for example.

This makes it possible to measure the effectiveness of the trainees.

What is claimed is:

1. A computer-implemented method for allocating computing resources in a method for protecting a computer-aided development environment in a distributed development process from damage and threats, the method comprising:
carrying out in the computer-aided development environment multiple methods for identifying damage and/or a threat;
determining, for each of the multiple methods, a metric which quantifies a quality and/or informative value of the method;
determining, for each of the multiple methods, a respective offer for allocating computing resources for the execution of the method, depending on the metric for the method; and
allocating the computing resources to the multiple methods depending on the respective offers.

2. The method according to claim 1, wherein each respective offer is taken from an available budget, or a budget is determined depending on the respective metric and the offer is taken from the budget determined depending on the metric.

3. The method according to claim 1, wherein each metric is determined depending on a number of errors found with the method or a number of lines of code analyzed with the method.

4. The method according to claim 3, wherein the number of errors or number of lines of code is normalized using a normalization parameter and the metric represents the number normalized using the parameter.

5. The method according to claim 2, the respective offer for each method is determined with a function parameterized with at least one parameter, which maps the metric to the respective offer depending on the at least one parameter or which maps the metric and the budget to the respective offer depending on the at least one parameter, wherein the at least one parameter is statically specified or is learned.

6. The method according to claim 5, wherein the at least one parameter is learned depending on the metric.

7. The method according to claim 1, characterized in that the metric and the respective offer are determined for each method in iterations and the computing resources are repeatedly allocated in iterations depending on the metrics or offers determined for the respective iteration.

8. The method according to claim 1, wherein the computing resources include: time slots of a computing time or memory areas of a memory or bandwidth of a data line.

9. The method according to claim 1, wherein the computing resources are provided on a server.

10. The method according to claim 1, wherein the computer-aided development environment is provided in the distributed development process on distributed devices.

11. The method according to claim 10, wherein at least one of the multiple methods for identifying the damage and/or the threat is carried out on one of the distributed devices to which the at least one of the multiple methods is assigned.

12. An apparatus for allocating computing resources in a method for protecting a computer-aided development environment in a distributed development process from damage and threats, the apparatus comprising:
at least one processor; and
at least one memory, wherein the at least one processor is configured to carry out instructions, upon execution of which by the at least one processor the apparatus carries out the following steps:
carrying out in the computer-aided development environment multiple methods for identifying damage and/or a threat,
determining, for each of the multiple methods, a metric which quantifies a quality and/or informative value of the method,
determining, for each of the multiple methods, a respective offer for allocating computing resources for the execution of the method, depending on the metric for the method, and
allocating the computing resources to the multiple methods depending on the respective offers; and
wherein the at least one memory stores the instructions.

13. A non-transitory medium on which is stored a computer program including computer-executable instructions for allocating computing resources in a method for protecting a computer-aided development environment in a distributed development process from damage and threats, the instructions, when executed by a computer, causing the computer to perform the following steps skill:
carrying out in the computer-aided development environment multiple methods for identifying damage and/or a threat;
determining, for each of the multiple methods, a metric which quantifies a quality and/or informative value of the method;
determining, for each of the multiple methods, a respective offer for allocating computing resources for the execution of the method, depending on the metric for the method; and
allocating the computing resources to the multiple methods depending on the respective offers.
